(19) United States
(12) Patent Application Publication
(10) Pub. No.: US 2026/0269221 A1
(43) Pub. Date: Sep. 10, 2026

(54) Negative Electrode for Lithium Secondary Battery and Manufacturing Method Thereof

(71) Applicant: LG Energy Solution, Ltd., Seoul (KR)

(72) Inventors: Jong Su Yoon, Daejeon (KR); Taek Soo Lee, Daejeon (KR); Jin Ho Cho, Daejeon (KR); Shin Wook Jeon, Daejeon (KR); Young Gon Kim, Daejeon (KR)

(73) Assignee: LG Energy Solution, Ltd., Seoul (KR)

(21) Appl. No.: 19/069,593

(22) Filed: Mar. 4, 2025

(51) Int. Cl. H01M 4/36; H01M 4/02; H01M 4/04; H01M 4/38; H01M 4/505; H01M 4/525; H01M 4/583; H01M 10/052

(52) U.S. Cl. CPC H01M 4/366; H01M 4/0404; H01M 4/0435; H01M 4/364; H01M 4/386; H01M 4/505; H01M 4/525; H01M 4/583; H01M 10/052; H01M 2004/021; H01M 2004/027; H01M 2004/028

(57) ABSTRACT

A negative electrode may have a structure in which a first negative electrode active layer and a second negative electrode active layer are sequentially stacked on a negative electrode current collector, and include synthetic graphite and natural graphite as carbon-based negative electrode active materials in the first negative electrode active layer, wherein by controlling the alignment (O.I₁ₛₜ) of the carbon-based negative electrode active material contained in the first negative electrode active layer and the content of synthetic graphite in a certain range, there is an advantage that the adhesion of the negative electrode active layer to the negative electrode current collector is excellent, and the life of the secondary battery including it is excellent.

### CROSS REFERENCE TO RELATED APPLICATIONS

The present application is a continuation in part of International Application No. PCT/KR2023/016609 filed on Oct. 25, 2023, which claims the benefit of priority based on Korean Patent Application No. 10-2022-0183044 filed on Dec. 23, 2022, the disclosures of which are incorporated herein by reference.

### TECHNICAL FIELD

The present disclosure relates to a negative electrode for a lithium secondary battery and a method of manufacturing the same.

### BACKGROUND

Recently, secondary batteries have been widely applied in small devices such as portable electronics, as well as in medium and large devices such as battery packs or power storage in hybrid vehicles or electric vehicles.

These secondary batteries are chargeable/dischargeable power generators comprising a laminated structure of a positive electrode/separator/negative electrode, with the positive electrode generally containing lithium metal oxide as a positive electrode active material and the negative electrode containing a carbon-based negative electrode active material such as graphite, so that lithium ions released from the positive electrode are absorbed into the carbon-based negative electrode active material of the negative electrode during charging, and lithium ions contained in the carbon-based negative electrode active material are absorbed into the lithium metal oxide of the positive electrode during discharging, and the charge and discharge are repeated.

Meanwhile, amorphous carbon or crystalline carbon is used as the negative electrode active material for the negative electrode, and among them, crystalline carbon is mainly used due to its high capacity. These crystalline carbons include graphite-based carbons such as natural graphite and synthetic graphite.

Different types of graphite-based carbon have different properties. For example, natural graphite exhibits high power output and excellent adhesion to the current collector, but it is relatively inferior to synthetic graphite in terms of resistance and life characteristics. However, since the synthetic graphite has fewer surface defects and functional groups, its adhesion to the current collector is weak, and when propylene carbonate (PC) is mixed with the electrolyte for the purpose of improving low-temperature performance, there is a problem that the propylene carbonate exfoliates and destroys each layer of the interlayer structure of the graphite.

Therefore, attempts have been made to apply mixed graphite as a negative electrode active material for lithium secondary batteries to utilize the advantages of each by appropriately combining the characteristics of each type. However, the adhesion of such mixed graphite to the current collector is reduced, and it is difficult to reach a satisfactory level in terms of life characteristics and impact stability.

Therefore, there is a need to develop new technologies that can utilize the benefits of graphite-based carbon as a negative electrode active material while addressing its drawbacks.

### SUMMARY

### Technical Problem

An aspect of the present disclosure provides a negative electrode for lithium secondary battery that includes graphite-based carbon as a negative electrode active material, has a high adhesion to a current collector, and has an excellent battery performance such as life characteristics, and a manufacturing method thereof.

### Technical Solution

To solve the above-mentioned problems, in an exemplary aspect, the present disclosure provides a negative electrode for lithium secondary battery including:
a negative electrode current collector; a first negative electrode active layer provided on at least one surface of the negative electrode current collector and containing carbon-based active material; and a second negative electrode active layer provided on the first negative electrode active layer and containing carbon-based active material, wherein
a first carbon-based negative electrode active material includes natural and synthetic graphite, and
the first negative electrode active layer has a first alignment (O.I₁ₛₜ) of the first carbon-based negative electrode active material and the second negative electrode active layer has a second alignment (O.I._{2nd}) of the second carbon-based negative electrode active material,
each of the first and second alignments (O.I) are from 0.1 to 0.9, as represented by Equation 1:

$$O . I = {I}_{004} / {I}_{110} \qquad [ Equation 1 ]$$

In Equation 1,
I₀₀₄ represents the area of the peak representing the [0,0,4] crystal face in the X-ray diffraction spectroscopy (XRD) measurement of the negative electrode active layer,
I₁₁₀ represents the area of the peak representing the [1,1,0] crystal face in an X-ray diffraction (XRD) measurement of the negative electrode active layer.

Here, the content of synthetic graphite may exceed 50 wt % with respect to the total weight of the first carbon-based negative electrode active material.

In addition, the second carbon-based negative electrode active material may include synthetic graphite.

Moreover, the alignment (O.I_{2nd}) of the secondary carbon-based negative electrode active material may have a ratio of 10% to 100% with respect to the alignment (O.I₁ₛₜ) of the first carbon-based negative electrode active material.

The above-mentioned synthetic graphite may be a flaky particle, and the natural graphite may be a spherical particle. In addition, the average particle size of synthetic graphite may be between 5 μm and 20 μm, the average particle size of natural graphite may be between 15 μm and 25 μm, wherein the average particle size of the synthetic graphite may be smaller than the average particle size of natural graphite.

Meanwhile, the total thickness of the first negative electrode active layer and the second negative electrode active layer may be 50 μm to 300 μm.

Here, the average thickness of the first negative electrode active layer may have a ratio of 10% to 100% with respect to the average thickness of the second negative electrode active layer.

Furthermore, in an exemplary aspect, the present disclosure provides a manufacturing method of a negative electrode for lithium secondary battery including:
applying a first negative electrode slurry including a first carbon-based negative electrode active material on a surface of a current collector and simultaneously applying a second negative electrode slurry including a second carbon-based negative electrode active material on a surface of the first negative electrode slurry;
applying a magnetic field to the applied first negative electrode slurry and the second negative electrode slurry; and
forming a first negative electrode active layer and a second negative electrode active layer by drying a first negative electrode slurry and a second negative electrode slurry in which a magnetic field is applied, wherein
a first carbon-based negative electrode active material includes natural and synthetic graphite, and
the first negative electrode active layer and the second negative electrode active layer each have an alignment (O.I) of a carbon-based negative electrode active material, represented by Equation 1 below, of 0.1 to 0.9, respectively:

$$O . I = {I}_{004} / {I}_{110} \qquad [ Equation 1 ]$$

In Equation 1,
I₀₀₄ represents the area of the peak representing the [0,0,4] crystal face in the X-ray diffraction spectroscopy (XRD) measurement of the negative electrode active layer,
I₁₁₀ represents the area of the peak representing the [1,1,0] crystal face in an X-ray diffraction (XRD) measurement of the negative electrode active layer.

Here, the magnetic field applied may be a magnetic field of 2,000G to 6,000G.

In addition, the magnetic field may be applied for 5 to 60 seconds.

Furthermore, forming a first negative electrode active layer and a second negative electrode active layer may include: drying the first negative electrode slurry and the second negative electrode slurry; and rolling a dried first negative electrode slurry and second negative electrode slurry.

### Advantageous Effects

The negative electrode for a lithium secondary battery according to the present disclosure has a structure in which a first negative electrode active layer and a second negative electrode active layer are sequentially stacked on a negative electrode current collector, and includes synthetic graphite and natural graphite as carbon-based negative electrode active materials in the first negative electrode active layer, wherein by controlling the alignment (O.I₁ₛₜ) of the carbon-based negative electrode active material contained in the first negative electrode active layer and the content of synthetic graphite in a certain range, there is an advantage that the adhesion of the negative electrode active layer to the negative electrode current collector is excellent, and the life of the secondary battery including it is excellent.

### BRIEF DESCRIPTION OF THE DRAWINGS

FIGS. 1 and 2 are scanning electron microscope images analyzing the shapes of synthetic graphite and natural graphite, respectively, among the carbon-based negative electrode active materials according to the present disclosure.

### DETAILED DESCRIPTION

Aspects of the present disclosure may have various modifications and various examples, and specific examples are illustrated in the drawings and described in detail in the description.

However, it should be understood that the present disclosure is not limited to specific aspects, and includes all modifications, equivalents, or alternatives within the spirit and technical scope of the present disclosure.

The terms “comprise,” “include” and “have” are used herein to designate the presence of characteristics, numbers, steps, actions, components, or members described in the specification or a combination thereof, and it should be understood that the possibility of the presence or addition of one or more other characteristics, numbers, steps, actions, components, members, or a combination thereof is not excluded in advance.

In addition, when a part of a layer, a film, a region, or a plate is disposed “on” another part, this includes not only a case in which one part is disposed “directly on” another part, but a case in which a third part is interposed there between. In contrast, when a part of a layer, a film, a region, or a plate is disposed “under” another part, this includes not only a case in which one part is disposed “directly under” another part, but a case in which a third part is interposed there between. In addition, in this disclosure, “on” may include not only a case of disposed on an upper part but also a case of disposed on a lower part.

In addition, in the present disclosure, “comprising as a major component” means that the defined component constitutes more than 50 wt % (or more than 50 volume %), more than 60 wt % (or more than 60 volume %), more than 70 wt % (or more than 70 volume %), more than 80 wt % (or more than 80 volume %), more than 90% by weight (or more than 90 volume %), or more than 95 wt % (or more than 95 volume %) with respect to the total weight (or total volume). For example, “comprising graphite as a major component of the negative electrode active material” could mean that graphite constitutes more than 50 wt %, more than 60 wt %, more than 70 wt %, more than 80 wt %, more than 90 wt %, or more than 95 wt % with respect to the total weight of the negative electrode active material, and in some cases, the entire negative electrode active material could be made of graphite, meaning that graphite constitutes 100 wt %.

Hereinafter, aspects of the present disclosure will be described in more detail.

### Negative Electrode for Lithium Secondary Battery

In an exemplary aspect, the present disclosure provides a negative electrode for lithium secondary battery including:
a negative electrode current collector; a first negative electrode active layer provided on at least one surface of the negative electrode current collector and containing carbon-based active material; and a second negative electrode active layer provided on the first negative electrode active layer and containing carbon-based active material, wherein
a first carbon-based negative electrode active material includes natural and synthetic graphite, and
the first negative electrode active layer has a first alignment (O.I₁ₛₜ) of the first carbon-based negative electrode active material and the second negative electrode active layer has a second alignment (O.I_{2nd}) of the carbon-based negative electrode active material, wherein each of the first and second alignments (O.I) are from 0.1 to 0.9, as represented by Equation 1 below:

$$O . I = {I}_{004} / {I}_{110} \qquad [ Equation 1 ]$$

In Equation 1,
I₀₀₄ represents the area of the peak representing the [0,0,4] crystal face in the X-ray diffraction spectroscopy (XRD) measurement of the negative electrode active layer,
I₁₁₀ represents the area of the peak representing the [1,1,0] crystal face in an X-ray diffraction (XRD) measurement of the negative electrode active layer.

A negative electrode for a lithium secondary battery according to the present disclosure includes a negative electrode active layer including a carbon-based active material on at least one side of the negative electrode current collector. The negative electrode active layer is a layer implementing the electrical activity of the negative electrode, and is prepared by applying an electrode slurry including the negative electrode active material, which implements an electrochemical redox reaction during charging and discharging of the battery, to both sides of the electrode current collector, followed by drying and rolling.

In this case, the negative electrode active layer includes a carbon-based active material as the negative electrode active material to implement electrical activity through a reversible redox reaction during charging and discharging of the battery. Specifically, the carbon-based active material refers to a material having carbon atoms as the main component, and such a carbon-based active material may include graphite-based carbon. The graphite-based carbon may include one or more among natural graphite or synthetic graphite.

The graphite-based carbon has a powder form, and the powder may comprise particles having a spherical, flaky, irregular, or other shape. Here, “flaky particles” means particles having a plate-like shape with a small thickness, and the surface of the particles normal to the thickness may have an average aspect ratio of 1:2 to 1:20. As used in the present disclosure, “aspect ratio” means a ratio of the shortest dimension in a single plane, to the longest dimension in a single plane.

In one example, the synthetic graphite may include flaky particles and the natural graphite may include spherical particles.

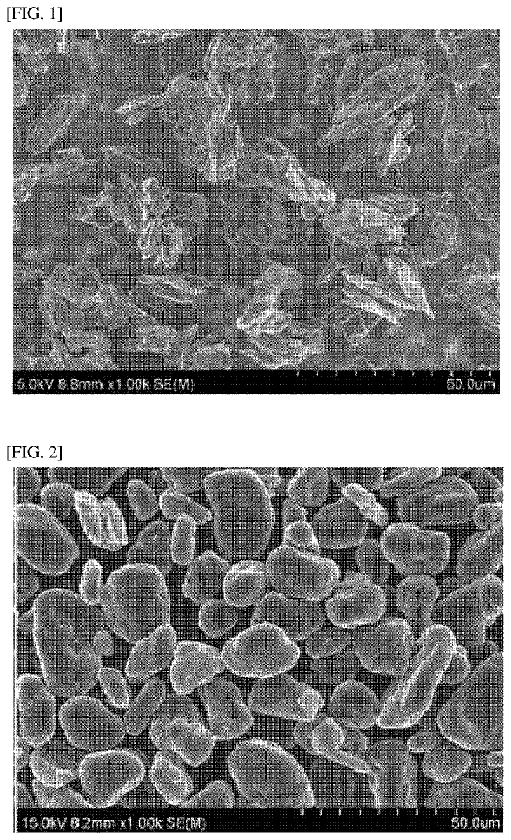

In this case, the synthetic graphite may have a structure that forms a spherical assembly formed by a plurality of flaky particles aggregated together, as shown in FIG. 1. Furthermore, one graphite assembly may be formed by an aggregation of 2 to 100, or 3 to 20, pieces of flaky shaped graphite. By controlling the particle shape of the synthetic graphite as described above, the present technology can improve the energy density. Furthermore, the specific surface area relative to the average size of the synthetic graphite can be increased, so that adhesion to the negative electrode current collector can be improved.

In addition, the natural graphite may include spherical particles as shown in FIG. 2, that may have a sphericity of greater than or equal to 0.75, for example, 0.75 to 1.0; 0.75 to 0.95; 0.8 to 0.95; or 0.90 to 0.99. As used herein, “sphericity” refers to the ratio of the shortest diameter (short diameter) to the longest diameter (long diameter) of any diameter passing through the center of the particle when the carbon-based negative electrode active material is projected as a two-dimensional particle, wherein a sphericity of 1 means that the particle has a spherical shape. The sphericity may be measured by a particle shape analyzer, or by analyzing particle images by scanning electron microscopy (SEM). The present technology has the advantage that by realizing the shape of natural graphite close to a spherical shape, the electrical conductivity of the negative electrode active layer can be high, thereby improving the capacity of the battery, and the specific surface area of the particles can be increased, thereby improving the adhesion between the negative electrode active layer and the current collector.

Further, the graphite-based carbon may be controlled so that its size satisfies a predetermined range. Specifically, the average particle size of the synthetic graphite may be 5 μm to 20 μm, the average particle size of the natural graphite may be 15 μm to 25 μm, and the average particle size of the natural graphite may be greater than the average particle size of the synthetic graphite. Here, the average particle size of the synthetic graphite refers to an average size of an assembly of a plurality of flaky particles.

Specifically, the average particle size (D50) of the synthetic graphite may be 5 μm to 15 μm; 5 μm to 12 μm; 10 μm to 20 μm; 15 μm to 20 μm; 12 μm to 18 μm; or 8 μm to 14 μm, and the average particle size (D50) of the natural graphite may be 15 μm to 20 μm; 20 μm to 25 μm; 18 μm to 23 μm; or 21 μm to 25 μm.

In one example, the synthetic graphite may have an average particle size of 8 μm to 10 μm, and the natural graphite may have an average particle size of 18 μm to 20 μm.

If the minimum particle diameter of synthetic graphite and natural graphite is less than 5 μm and 15 μm, respectively, a large amount of binder is required due to the increase in the number of particles per unit volume. This may result in a decrease in the electrical properties of the negative electrode and a high volume change rate due to shrinkage and expansion of the negative electrode active material during charge and discharge of the battery. This may reduce the durability of the negative electrode active layer. On the other hand, when the maximum particle diameter of synthetic graphite and natural graphite exceeds 20 μm and 25 μm, respectively, the expansion becomes severe, and the cohesion between particles and the cohesion between particles and the current collector decreases as the charge and discharge are repeated, which can significantly reduce the cycling characteristics.

Furthermore, by controlling the average particle size of the synthetic graphite to be smaller than the natural graphite, the present technology may implement a structure in which the synthetic graphite is densely packed between the plurality of natural graphite contained in the negative electrode active layer. With such a structure, the negative electrode of the present disclosure can have a reduced resistance of the negative electrode active layer and an increased energy density of the negative electrode, resulting in a better output performance.

On the other hand, the negative electrode active layer may have a structure in which two separate layers are stacked. Specifically, the negative electrode according to the present disclosure may have a structure in which a first negative electrode active layer is provided on the negative electrode current collector and a second negative electrode active layer is provided on the first negative electrode active layer. By implementing the structure of the negative electrode active layer as a two-layer structure, the present disclosure can more easily control the properties required for each region of the negative electrode active layer. In other words, the negative electrode active layer according to the present disclosure has the advantage of realizing a higher adhesion between the active layer and the negative electrode current collector in the region adjacent to the negative electrode current collector, and a higher density of energy generated by the electrochemical reaction in the region adjacent to the surface of the active layer, where a higher density of electrochemical reaction appears.

To this end, the first negative electrode active layer and the second negative electrode active layer comprising the negative electrode active layer may have different compositions.

Specifically, the first negative electrode active layer includes a first carbon-based negative electrode active material and the second negative electrode active layer includes a second carbon-based negative electrode active material. In this case, the first carbon-based active material and the second carbon-based active material include at least one type of graphite-based carbon among natural graphite and synthetic graphite, but the type and content/content ratio of the graphite-based carbon contained in each carbon-based active material may be different.

In one example, the first carbon-based negative electrode active material may include natural graphite and synthetic graphite, and the second carbon-based negative electrode active material may include only synthetic graphite.

Here, the first carbon-based negative electrode active material may include synthetic graphite in an amount greater than 50 wt % based on the total weight of the first carbon-based negative electrode active material, or more specifically, in an amount greater than 60 wt %, greater than 65 wt %, greater than 70 wt %, greater than 75 wt %, greater than 80 wt %, 60 wt % to 99 wt %, 60 wt % to 90 wt %, 65 wt % to 95 wt %, 70 wt % to 95 wt %, 75 wt % to 95 wt %, or 75 wt % to 90 wt % based on the total weight of the first carbon-based negative electrode active material.

In other examples, the first carbon-based negative electrode active material may include natural graphite and synthetic graphite, and the second carbon-based negative electrode active material may also include both natural graphite and synthetic graphite. In some examples, the percentage of synthetic graphite in the first carbon-based negative electrode active material may be smaller than the percentage of synthetic graphite in the second carbon-based negative electrode active material.

Here, the first carbon-based negative electrode active material may include synthetic graphite in an amount greater than 50 wt % based on the total weight of the first carbon-based negative electrode active material, or more specifically, in an amount greater than 60 wt %, greater than 65 wt %, greater than 70 wt %, greater than 75 wt %, greater than 80 wt %, 60 wt % to 99 wt %, 60 wt % to 90 wt %, 65 wt % to 95 wt %, 70 wt % to 95 wt %, 75 wt % to 95 wt %, or 75 wt % to 90 wt % based on the total weight of the first carbon-based negative electrode active material.

Here, the second carbon-based negative electrode active material may include synthetic graphite in an amount greater than 50 wt % based on the total weight of the second carbon-based negative electrode active material, or more specifically, in an amount greater than 60 wt %, greater than 65 wt %, greater than 70 wt %, greater than 75 wt %, greater than 80 wt %, or greater than 90 wt % based on the total weight of the second carbon-based negative electrode active material.

By controlling the content of synthetic graphite in the first carbon-based negative electrode active material contained in the first negative electrode active layer in the above range, the electrical resistance in the area adjacent to the negative electrode current collector can be reduced, so that the high power performance of the negative electrode can be improved, and the deterioration of the negative electrode active layer can be suppressed when the secondary battery is charged and discharged for a long time.

Furthermore, the negative electrode according to the present disclosure may have each of the first carbon-based negative electrode active material and the second carbon-based negative electrode active material contained in the first negative electrode active layer and the second negative electrode active layer oriented at a predetermined angle. Here, “orienting (or aligning) the carbon-based negative electrode active material” means that certain crystal faces representing the planar molecular structure of the carbon-based negative electrode active material, specifically graphite-based carbon, are arranged to have a predetermined angle/slope with respect to the negative electrode current collector. This is different from the fact that particles of graphite-based carbon themselves are arranged so that certain faces are at a certain angle/slope to the negative electrode current collector.

In the present disclosure, the carbon-based negative electrode active material, e.g., graphite-based carbon, contained in the negative electrode active layer may be aligned such that its crystal faces are near perpendicular to the negative electrode current collector, more specifically, it may be aligned such that it has an angle of 60° or more, 70° or more, 70-90°, 80-90°, 65-85°, or 70-85° with respect to the negative electrode current collector. The alignment of such carbon-based negative electrode active materials (e.g., graphite-based carbon) can be determined by crystallographic analysis of the carbon-based active materials contained in the negative electrode active layer.

In one example, the negative electrode active layer may be such that the carbon-based active material is aligned in a certain direction with respect to the negative electrode current collector, such that an X-ray diffraction spectroscopy (XRD) measurement of the negative electrode active layer shows an average alignment of the carbon-based active material, represented by Equation 1 below, of 0.1 to 0.9:

$$O . I = {I}_{004} / {I}_{110} \qquad [ Equation 1 ]$$

In Equation 1,
I₀₀₄ represents the area of the peak representing the [0,0,4] crystal face in the X-ray diffraction spectroscopy (XRD) measurement of the negative electrode active layer,
I₁₁₀ represents the area of the peak representing the [1,1,0] crystal face in an X-ray diffraction (XRD) measurement of the negative electrode active layer.

Equation 1 may be an indicator of the degree to which the crystal structure of the carbon-based active material, namely graphite-based carbon, is aligned in a certain direction, specifically with respect to the surface of the negative electrode current collector, as measured by X-ray diffraction. More specifically, during X-ray diffraction measurements, the negative electrode active layer shows peaks for graphite, which is a carbon-based active material, at 2θ=26.5±0.2°, 42.4±0.2°, 43.4±0.2°, 44.6±0.2°, 54.7±0.2°, and 77.5±0.2°. These represent the [0,0,2], [1,0,0], [1,0,1] R, [1,0,1] H, [0,0,4], and [1,1,0] crystal faces of the graphite contained in the negative electrode active layer. In addition, the peak at 2θ=43.4±0.2° can be seen as an overlap of the peaks corresponding to the [1,0,1] R plane of carbon-based materials and the [1,1,1] plane of current collectors, such as Cu.

Among these, the ratio of the area of the peak at 2θ=77.5±0.2°, representing the [1,1,0] plane, to the peak at 2θ=54.7±0.2°, representing the [0,0,4] plane, specifically the ratio of the areas obtained by integrating the intensity of these peaks, can measure the degree of alignment (O.I) of the carbon-based active material (i.e., the graphite-based carbon). Since the peak at 2θ=54.7±0.2° represents the [0,0,4] plane of graphite, which has a slope relative to the negative electrode current collector, the alignment degree (O.I) suggests that values closer to 0 indicate a slope of approximately 90° relative to the surface of the negative electrode current collector, and higher values suggest a slope closer to 0° or 180°.

In this aspect, the negative electrode active layer according to the present disclosure can have the carbon-based active material aligned nearly perpendicular to the negative electrode current collector, for example, at angles of 60° or more, 70° or more, 70°~90°, 80°~90°, 65°~85°, or 70°~85°, resulting in a lower alignment O.I compared to cases where the carbon-based active material is not vertically aligned.

Furthermore, the negative electrode of the present disclosure can have the carbon-based active material contained in the first and second negative electrode active layers, respectively, aligned in a certain direction relative to the negative electrode current collector, allowing the carbon-based active materials contained in the first and second active layers to have different alignments (O.I). Specifically, the first carbon-based active material in the first negative electrode active layer can have a higher alignment (O.I) than the second carbon-based active material in the second negative electrode active layer.

In one example, the alignment (O.I_{2nd}) of the second carbon-based active material contained in the second negative electrode active layer may have a ratio of 10% to 100% with respect to the alignment (O.I₁ₛₜ) of the carbon-based active material contained in the first negative electrode active layer, more specifically, a ratio of 50% to 99%; 60% to 99%; 70% to 99%; 80% to 99%; or 60% to 85%.

In this case, the alignment (O.I_{2nd}) of the carbon-based active material contained in the second negative electrode active layer may be 0.1 to 0.9, and more specifically may be 0.1 to 0.7; 0.1 to 0.5; 0.2 to 0.6; 0.4 to 0.7; 0.3 to 0.5; or 0.1 to 0.4.

In the negative electrode according to the present disclosure, by controlling the alignment (O.I) of the carbon-based active materials contained in the first negative electrode active layer and in the second negative electrode active layer, respectively, as described above; the electrolyte and lithium mobility in the second negative electrode active layer can be improved, thereby increasing the electrode capacity; and the adhesion of the first negative electrode active layer and the negative electrode current collector can be further strengthened.

Further, in the second negative electrode active layer, the second carbon-based negative electrode active material is aligned to have a certain angle/slope to the negative electrode current collector, so that it may exhibit a predetermined color difference value upon CIE colorimetric analysis of any three points located on the surface.

In one example, the second negative electrode active layer may have an L* value of 40 or less and a ΔL* of less than 10 in a CIE colorimetric analysis of any three points located on the surface. More specifically, the L* value may be 30 to 40; 30 to 35; 32 to 35; or 31 to 34.5, and the ΔL* may be less than 8, less than 5, less than 3, or less than 2, based on a CIE colorimetric analysis of any three points located on the surface of the negative electrode active layer.

The L* value is a factor indicating the brightness of a color, where L*=0 indicates black, and L*=100 indicates white. The negative electrode active layer in the present disclosure is a carbon-based negative electrode active material containing graphite as the main component, which exhibits a black color and thus has an L* of 30 or more, and the graphite contained in the negative electrode active layer is uniformly crystalline oriented with respect to the negative electrode current collector, so that the deviation of L* at multiple points (i.e., ΔL*) can be low.

Meanwhile, the total thickness of the first negative electrode active layer and the second negative electrode active layer may be from 50 μm to 300 μm, more specifically from 50 μm to 250 μm; from 100 μm to 250 μm; or from 100 μm to 200 μm. By adjusting the total thickness of the negative electrode active layer to the above range, the present technology can not only increase the energy density of the electrode, but also uniformly control the alignment of the carbon-based active material contained in the negative electrode active layer.

Furthermore, the average thickness of the first negative electrode active layer may have a ratio of 10% to 100% with respect to the average thickness of the second negative electrode active layer, more specifically, it may have a ratio of 10% to 50%; 10% to 40%; 30% to 50%; 40% to 70%; 50% to 99%; 60% to 99%; 70% to 99%; 60% to 85%; or 80% to 100% with respect to the average thickness of the second negative electrode active layer. By adjusting the average thickness of the first negative electrode active layer to the above range, the present technology can improve the adhesion of the negative electrode active layer to the negative electrode current collector while facilitating an increase in the charge/discharge capacity and power output that the entire negative electrode active layer can implement.

Meanwhile, the first negative electrode active layer and the second negative electrode active layer according to the present disclosure may further include a silicon-based negative electrode active material together with a carbon-based negative electrode active material.

Such a silicon-based negative electrode active material may include a silicon-based material including at least one of silicon (Si), silicon carbide (SiC), silicon monoxide (SiO), or silicon dioxide (SiO2). Here, the silicon-based material may be represented by silicon oxide (SiOq, wherein 0.8≤q≤2.5) when silicon monoxide (SiO) and silicon dioxide (SiO2) are uniformly mixed or compounded and included in the negative electrode active layer.

Furthermore, the silicon-based negative electrode active material may be included in an amount of 1 to 20 wt % based on the total weight of the negative electrode active material contained in each negative electrode active layer, and more specifically from 1 to 9 wt %, 3 to 7 wt %, 5 to 15 wt %, 11 to 19 wt %, or 13 to 17 wt % based on the total weight of the negative electrode active material. The total weight of the negative electrode active material may be the sum of the weight of the carbon-based negative electrode active material the silicon-based negative electrode active material.

By adjusting the content of the silicon-based negative electrode active material to the above range, the present technology can minimize the rate of change of the volume of the negative electrode active layer with charge and discharge, and at the same time improve the charge capacity per unit mass while reducing the lithium consumption and irreversible capacity loss during the initial charge and discharge of the battery.

Furthermore, the first negative electrode active layer and the second negative electrode active layer according to the present disclosure may optionally further include, in addition to the negative electrode active material, a conductive material, a binder, other additives, and the like as required.

The conductive material may include one or more types among carbon black, acetylene black, ketjen black, carbon nanotubes, carbon fiber, and the like, but is not limited thereto.

In one example, the negative electrode active layer may contain carbon black, carbon nanotubes, carbon fibers, or the like as a conductive material, either alone or in combination. In this case, the content of the conductive material may be 0.1 to 10 parts by weight, more specifically, 0.1 to 8 parts by weight, 0.1 to 5 parts by weight, 0.1 to 3 parts by weight, 2 to 6 parts by weight, or 0.5 to 2 parts by weight, relative to the total 100 parts by weight of the negative electrode active layer. By controlling the content of the conductive material to the above range, the present technology can prevent the resistance of the negative electrode from increasing due to a low content of the conductive material, thereby reducing the charging capacity. Additionally, by controlling the content of the conductive material to the above range, the present technology can prevent the content of the negative electrode active material from decreasing due to an excessive amount of the conductive material, thereby reducing the charging capacity. Furthermore, by controlling the content of the conductive material to the above range, the present technology can prevent the rapid charging characteristics from decreasing due to an increase in the loading amount of the negative electrode active layer.

Furthermore, the binder may be suitably applied as a component that assists in the bonding of the active material and the conductive material and the like to the current collector, to the extent that it does not degrade the electrical properties of the electrode. Specifically, it may include one or more binders selected from the group consisting of vinylidene fluoride-hexafluoropropylene copolymer (PVDF-co-HFP), polyvinylidenefluoride (PVdF), polyacrylonitrile, polymethylmethacrylate, polyvinyl alcohol, carboxymethylcellulose (CMC), starch, hydroxypropylcellulose, regenerated cellulose, polyvinylpyrrolidone, tetrafluoroethylene, polyethylene, polypropylene, polyacrylic acid, ethylene-propylene-diene monomer, sulfonated ethylene-propylene-diene monomer, styrene-butadiene rubber, and fluorinated rubber.

The content of the binder may be from 0.1 to 10 parts by weight, more specifically from 0.1 to 8 parts by weight, from 0.1 to 5 parts by weight, from 0.1 to 3 parts by weight, or from 2 to 6 parts by weight, based on a total of 100 parts by weight of the negative electrode active layer. By controlling the content of the binder contained in the negative electrode active layer to the above range, the present technology can prevent the adhesion of the active layer from deteriorating due to a low content of binder. Additionally, controlling the content of the binder contained in the negative electrode active layer to the above range, the present technology can prevent the electrical properties of the electrode from deteriorating due to an excess of binder.

Furthermore, the negative electrode current collector is not particularly limited as long as it has a high conductivity without causing chemical changes in the battery. For example, copper, stainless steel, nickel, titanium, calcined carbon, and the like may be used. In the case of copper or stainless steel, those that are surface treated with carbon, nickel, titanium, silver, and the like may also be used. Furthermore, the average thickness of the negative electrode current collector may be suitably applied from 1 to 500 μm, considering the conductivity and total thickness of the negative electrode being manufactured.

### Lithium Secondary Battery

Furthermore, in an exemplary aspect, the present disclosure provides a lithium secondary battery including an electrode assembly including a positive electrode, a negative electrode of the present disclosure as described above, and a separator disposed between the positive electrode and negative electrode.

A lithium secondary battery according to the present disclosure includes an electrode assembly having a plurality of positive electrodes, separators, and negative electrodes each arranged sequentially; and an electrolyte composition having a lithium salt and an electrolyte additive dissolved in a non-aqueous organic solvent. In this case, the lithium secondary battery includes the negative electrode of the present disclosure having a structure in which a first negative electrode active layer and a second negative electrode active layer are sequentially stacked on the negative electrode current collector, and includes synthetic graphite and natural graphite as carbon-based negative electrode active materials in the first negative electrode active layer, wherein the alignment (O.I₁ₛₜ) of the carbon-based negative electrode active material contained in the first negative electrode active layer and the content of synthetic graphite is controlled in a certain range. Accordingly, the lithium secondary battery has the advantage of excellent adhesion between the negative electrode active layer and the negative electrode current collector, and the secondary battery including the negative electrode has an excellent battery life.

The negative electrode has the same configuration as described above, so the specific description is omitted.

In addition, the positive electrode is provided with a positive electrode active layer prepared by applying, drying, and pressing a slurry including a positive electrode active material onto the positive electrode current collector, and may optionally further include a conductive material, a binder, other additives, and the like, as desired.

The positive electrode active material is a material capable of electrochemically reacting on the positive electrode current collector and may include one or more of the lithium metal oxides represented by Chemical Formula 1 and Chemical Formula 2 below that are capable of reversibly intercalating and deintercalating lithium ions:

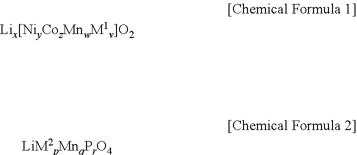

In Chemical Formulas 1 and 2,
M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo,
x, y, z, w, and v are 1.0≤x≤1.30, 0.5≤y<1, 0<z≤0.3, 0<w≤0.3, 0≤v≤0.1, respectively, where y+z+w+v=1,
M² is Ni, Co, or Fe,
p is 0.05≤p≤1.0,
q is either 1-p or 2-p, and
r is 0 or 1.

The lithium metal oxides represented by Chemical Formulas 1 and 2 contain high amounts of nickel (Ni) and manganese (Mn), respectively, and when used as positive electrode materials, offer the advantage of being able to stably supply high capacity and/or high voltage electricity.

Here, examples of lithium metal oxides represented by Chemical Formula 1 include LiNi_{0.8}Co_{0.1}Mn_{0.1}O₂, LiNi_{0.6}Co_{0.2}Mn_{0.2}O₂, LiNi_{0.9}Co_{0.05}Mn_{0.05}O₂, LiNi_{0.6}Co_{0.2}Mn_{0.1}Al_{0.1}O₂, LiNi_{0.6}Co_{0.2}Mn_{0.15}Al_{0.05}O₂, or LiNi_{0.7}Co_{0.1}Mn_{0.1}Al_{0.1}O₂, etc., and lithium metal oxides represented by Chemical Formula 2 may include LiNi_{0.7}Mn_{1.3}O₄; LiNi_{0.5}Mn_{1.5}O₄; LiNi_{0.3}Mn_{1.7}O₄, LiFePO₄, or LiFe_{q}Mn_{1-q}PO₄, etc., which may be used alone or in combination.

Additionally, the positive electrode active material may be included in an amount of 85 parts by weight or more based on the weight of the positive electrode active layer, specifically, 90 parts by weight or more, 93 parts by weight or more, or 95 parts by weight or more.

Furthermore, the positive electrode active layer may further include a conductive material, a binder, and other additives in addition to the positive electrode active material.

Here, the conductive material is used to improve the electrical performance of the positive electrode, can be applied as commonly utilized in the industry, but specifically, it may include one or more types selected from a group consisting of natural graphite, synthetic graphite, carbon black, acetylene black, Denka black, Ketjen black, Super-P, channel black, furnace black, lamp black, summer black, graphene, and carbon nanotubes.

Furthermore, the conductive material may be included in an amount of 0.1 to 5 parts by weight based on the weight of each positive electrode active layer, more specifically 0.1 to 4 parts by weight; 2 to 4 parts by weight; 1.5 to 5 parts by weight; 1 to 3 parts by weight; 0.1 to 2 parts by weight; or 0.1 to 1 part by weight.

Moreover, the binder serves to bind the positive electrode active material, positive electrode additives, and conductive material together, and it may be used without being limited as long as it possesses this function. Specifically, the binder may include one or more types of resins selected from a group consisting of polyvinylidene fluoride-hexafluoropropylene copolymer (PVdF-co-HFP), polyvinylidene fluoride (PVdF), polyacrylonitrile, polymethylmethacrylate, and copolymers thereof. As an example, the binder may include polyvinylidenefluoride (PVdF).

In addition, the binder may be included in an amount of 1 to 10 parts by weight based on the weight of each positive electrode active layer, specifically may be included in the amount of 2 to 8 parts by weight; or 1 to 5 parts by weight.

The total thickness of the positive electrode active layer is not specifically limited, but it may be between 50 μm to 300 μm, more specifically, 100 μm to 200 μm; 80 μm to 150 μm; 120 μm to 170 μm; 150 μm to 300 μm; 200 μm to 300 μm; or 150 μm to 190 μm.

In addition, as a positive electrode current collector, the positive electrode may use one that does not induce chemical changes in the battery while possessing high conductivity. For example, stainless steel, aluminum, nickel, titanium, vitreous carbon, etc. may be used. In cases of aluminum or stainless steel, those that are surface treated with carbon, nickel, titanium, silver, etc., may be used. Additionally, the average thickness of the current collector can be appropriately applied between 3 to 500 μm, considering the conductivity and total thickness of the positive electrode to be manufactured.

Meanwhile, the separator interposed between the positive electrode and negative electrode of each unit cell is an insulating thin film with high ion permeability and mechanical strength. It is not particularly limited as long as it is conventionally used in the industry, but specifically may use those including one or more types of polymers such as chemically resistant and hydrophobic polypropylene; polyethylene; polyethylene-propylene copolymer. The separator may have the form of a porous polymeric substrate, such as a sheet or nonwoven fabric including the polymer described above. In some cases, the separator may have the form of a composite separator in which organic or inorganic particles are coated by an organic binder on the porous polymeric substrate. Furthermore, the separator may have an average pore diameter of 0.01 to 10 μm, and an average thickness of 5 to 300 μm.

Meanwhile, the lithium secondary battery according to the present disclosure is not specifically limited but may take the form of a secondary battery that includes a stack type; zigzag type; or zigzag-stack type electrode assembly. For instance, the lithium secondary battery according to the present disclosure may be a pouch-type secondary battery or a prismatic secondary battery.

### Manufacturing Method of Negative Electrode

Furthermore, in an exemplary aspect, the present disclosure provides a manufacturing method of a negative electrode for lithium secondary battery including:
applying a first negative electrode slurry including a first carbon-based negative electrode active material on a surface of a current collector and simultaneously applying a second negative electrode slurry including a second carbon-based negative electrode active material on a surface of the first negative electrode slurry;
applying a magnetic field to the applied first negative electrode slurry and the second negative electrode slurry; and
forming a first negative electrode active layer and a second negative electrode active layer by drying a first negative electrode slurry and a second negative electrode slurry to which the magnetic field was applied, wherein
a first carbon-based negative electrode active material includes natural and synthetic graphite, and
the first negative electrode active layer has a first alignment (O.I₁ₛₜ) of the first carbon-based negative electrode active material and the second negative electrode active layer has a second alignment (O.I_{2nd}) of the second carbon-based negative electrode active material, wherein each of the first and second alignments (O.I) are from 0.1 to 0.9, as represented by Equation 1 below:

$$O . I = {I}_{004} / {I}_{110} \qquad [ Equation 1 ]$$

In Equation 1,
I₀₀₄ represents the area of the peak representing the [0,0,4] crystal face in the X-ray diffraction spectroscopy (XRD) measurement of the negative electrode active layer,
I₁₁₀ represents the area of the peak representing the [1,1,0] crystal face in an X-ray diffraction (XRD) measurement of the negative electrode active layer.

A method for manufacturing a negative electrode according to the present disclosure is to apply a negative electrode slurry including a carbon-based active material on a negative electrode current collector, apply a magnetic field to a surface of the applied negative electrode slurry to align the carbon-based active material in the negative electrode slurry to have a predetermined angle with respect to the surface of the negative electrode current collector, and subsequently dry the negative electrode slurry with a reduced disorder of the carbon-based active material to form a negative electrode active layer.

Here, applying the negative electrode slurry may be performed at once by simultaneously discharging two negative electrode slurries onto the negative electrode current collector.

Specifically, applying the negative electrode slurry may be performed by simultaneously applying a first negative electrode slurry including a first carbon-based negative electrode active material and a second negative electrode slurry including a second carbon-based negative electrode active material onto the negative electrode current collector.

In this case, the first negative electrode slurry and the second negative electrode slurry may have different compositions. Specifically, the first negative electrode slurry includes a first carbon-based negative electrode active material and the second negative electrode slurry includes a second carbon-based negative electrode active material. In this case, the first carbon-based active material and the second carbon-based active material include at least one type of graphite-based carbon among natural graphite and synthetic graphite, but the type and content/content ratio of the graphite-based carbon contained in each carbon-based active material may be different.

In one example, the first carbon-based negative electrode active material may include natural graphite and synthetic graphite, and the second carbon-based negative electrode active material may include only synthetic graphite.

The configurations for particle shape, average particle size, etc. for natural graphite and synthetic graphite have the same configurations as those described above, so specific descriptions will be omitted.

Furthermore, applying the first negative electrode slurry and applying the second negative electrode slurry may be applied without being limited as long as it is a method conventionally applied in the art. For example, the application may be performed by dip coating, die coating, comma coating, gravure coating, or bar coating methods, for example by die coating utilizing a dual slot die.

Furthermore, applying a magnetic field to the first negative electrode slurry and the second negative electrode slurry may be a step of aligning the crystal faces of the carbon-based active material contained in each negative electrode slurry to have a predetermined angle with respect to the negative electrode current collector. For this purpose, applying a magnetic field may apply a magnetic field to the surface of the negative electrode slurry applied sequentially on the negative electrode current collector, i.e., the exposed surface of the second negative electrode slurry, such that the first negative electrode slurry located in the lower part of the second negative electrode slurry may also have the crystal surface of the carbon-based negative electrode active material aligned at a predetermined angle by the applied magnetic field.

Here, the alignment (O.I) of the carbon-based active materials in each of the aforementioned negative electrode slurries can be controlled by the strength of the applied magnetic field or the time of exposure to the magnetic field.

For example, applying the magnetic field may include applying a magnetic field of 2,000 G (Gauss) to 6,000 G (Gauss), more specifically, a magnetic field of 2,500 G to 5,500 G; 3,000 G to 5,500 G; 3,500 G to 5,500 G; 4,000 G to 5,500 G; 3,500 G to 4,500 G; or 4,500 G to 5,000 G.

Further, applying the magnetic field may be performed for a period of 5 seconds to 60 seconds, and more particularly, may be performed for a period of 10 seconds to 60 seconds; 10 seconds to 30 seconds; 30 seconds to 60 seconds; 40 seconds to 50 seconds; 15 seconds to 35 seconds; or 10 seconds to 50 seconds. The degree to which the carbon-based cathode active material is aligned depends on the magnetic field's applied strength and time, among other factors. Therefore, controlling for other variables, the longer the magnetic field is applied to the carbon-based cathode active material, the better the alignment, in which case the O.I value will be lower.

In one example, applying the magnetic field may include applying a magnetic field of 4,700±100 G to the negative electrode slurry for 12 seconds to 33 seconds.

By applying a magnetic field to the second negative electrode slurry to satisfy the magnetic field strength and application time described above in the step of applying the magnetic field, the present technology can align the second carbon-based negative electrode active material contained in the second negative electrode slurry as well as the first carbon-based active material of the first negative electrode slurry located in the lower part of the second negative electrode slurry to have a predetermined angle with respect to the negative electrode current collector.

Further, forming the first negative electrode active layer and the second negative electrode active layer may include the steps of drying the first negative electrode slurry and the second negative electrode slurry; and rolling the dried first negative electrode slurry and the second negative electrode slurry.

In this case, drying the first negative electrode slurry and the second negative electrode slurry may be applied without being particularly limited as long as it is a method that is capable of maintaining the alignment of the carbon-based active material contained within the negative electrode active layer.

For example, the drying step may include drying the negative electrode slurry by applying thermal energy to the negative electrode slurry using a hot air dryer, a vacuum oven, or the like.

Furthermore, rolling the dried negative electrode slurry is a step of increasing the density of the negative electrode active layer by applying pressure to the dried negative electrode slurry using a roll press or the like. At this time, the rolling may be performed at a temperature condition higher than room temperature.

Specifically, the rolling may be performed at a temperature of from 50° C. to 100° C., more specifically from 60° C. to 100° C.; 75° C. to 100° C.; 85° C. to 100° C.; 50° C. to 90° C.; 60° C. to 80° C.; or 65° C. to 90° C. More specifically, the rolling may be performed at a rolling speed of 2 m/s to 7 m/s, more specifically, 2 m/s to 6.5 m/s; 2 m/s to 6 m/s; 2 m/s to 5.5 m/s; 2 m/s to 5 m/s; 2 m/s to 4.5 m/s; 2 m/s to 4 m/s; 2.5 m/s to 4 m/s; 2.5 m/s to 3.5 m/s; 3.5 m/s to 5 m/s; 5 m/s to 7 m/s; 5.5 m/s to 6.5 m/s; or 6 m/s to 7 m/s. Furthermore, the rolling may be performed under a pressure condition of 50 MPa to 200 MPa, more specifically, under a pressure condition of 50 MPa to 150 MPa; 50 MPa to 100 MPa; 100 MPa to 200 MPa; 150 MPa to 200 MPa; or 80 MPa to 140 MPa.

By performing the rolling of the dried negative electrode slurry under the temperature, speed and/or pressure conditions, the present technology can increase the energy density of the negative electrode while minimizing the change in the alignment of the carbon-based active materials contained in the first negative electrode active layer and the second negative electrode active layer formed.

In addition to the carbon-based active material, the negative electrode slurry may further include a conductive material, a binder, a thickener, and the like, which are conventionally used in the art.

### EXAMPLES

Hereinafter, aspects of the present disclosure will be described in more detail by way of examples and experimental examples.

However, the following examples and experimental examples are only illustrative of aspects of the present disclosure, and the contents of the present disclosure are not limited to the following examples and experimental examples.

### Examples 1 to 4 and Comparative Examples 1 to 2: Preparation of a Negative Electrode for a Lithium Secondary Battery

A negative electrode for lithium secondary battery was prepared by reflecting the conditions shown in Table 1 below.

First, natural graphite and synthetic graphite were prepared as carbon-based active materials, carbon black was prepared as a conductive material, and carboxymethylcellulose (CMC) and styrene butadiene rubber (SBR) were prepared as a binder.

A first negative electrode slurry and second negative electrode slurry were prepared by mixing 95 parts by weight of the prepared carbon-based negative electrode active material, 1 part by weight of carbon black, 1.5 parts by weight of carboxymethylcellulose (CMC), and 2.5 parts by weight of styrene butadiene rubber (SBR) with water to achieve 50% solids.

At this time, the first carbon-based negative electrode active material included in the first negative electrode slurry was controlled for \textcircled{1} particle shape, \textcircled{2} average particle size, and \textcircled{3} content in each carbon-based negative electrode active material as shown in Table 1 below. However, if the particle shape of the carbon-based negative electrode active material was spherical, the sphericity degree satisfied between 0.70 and 0.95. In addition, the second carbon-based negative electrode active material included in the second negative electrode slurry was the same as the synthetic graphite included in the first carbon-based negative electrode active material.

Once each negative electrode slurry was prepared, the first negative electrode slurry and the second negative electrode slurry were simultaneously cast onto a copper thin plate (thickness: 8 μm) under roll-to-roll transfer (transfer speed: 5 m/min) using a dual die coater. At this time, the first negative electrode slurry and the second negative electrode slurry were cast so that the average thickness was 90 μm and 100 μm, respectively, along the transfer direction of the copper thin plate.

Then, a magnetic field of 4,750±50 G was applied to the surface of the applied second negative electrode slurry for the time as shown in Table 1, and the negative electrode slurry applied with a magnetic field was hot air dried to form a negative electrode active layer. The formed negative electrode active layer was rolled at 50±1° C. with a pressure of 100-150 MPa and a transfer rate of 3 m/s to prepare the negative electrode for lithium secondary battery.

TABLE 1

| | First carbon-based negative electrode active material | | | | | | Magnetic |
|---|---|---|---|---|---|---|---|
| | Natural graphite | | | Synthetic graphite | | | field |
| | | Particle | Content | | Particle | Content | application |
| | Shape | size [μm] | [wt %] | Shape | size [μm] | [wt %] | time [Sec.] |
| Example 1 | Spherical | 20 | 5 | Flaky | 17 | 95 | 15 |
| Example 2 | Spherical | 20 | 20 | Flaky | 17 | 80 | 15 |
| Example 3 | Spherical | 20 | 60 | Flaky | 17 | 40 | 15 |
| Example 4 | Spherical | 20 | 20 | Flaky | 17 | 80 | 3 |
| Comparative Example 1 | Spherical | 20 | 100 | — | — | — | 15 |
| Comparative Example 2 | — | — | — | Flaky | 17 | 100 | 15 |

X-ray diffraction spectroscopy (XRD) of the first negative electrode active layer and the second negative electrode active layer was performed on the prepared negative electrodes to measure the spectra. Here, for the spectrum of the first negative electrode active layer, the second negative electrode active layer was removed by exfoliating the second negative electrode active layer after X-ray diffraction spectroscopy (XRD) measurement of the second negative electrode active layer, and X-ray diffraction was measured on the exposed surface of the first negative electrode active layer, and the measurement conditions of the X-ray diffraction (XRD) are as follows:
Target: Cu (Kα ray) graphite monochromator
Slit: Diverging slit=1 degree, receiving slit=0.1 mm, scattering slit=1 degree.
Measurement area: [1,1,0] plane: 76.5 degrees<2θ<78.5 degrees/[0,0,4] plane: 53.5 degrees<2θ<56.0 degrees.

From the spectra measured under the above conditions, the average alignment (O.I) of each carbon-based active material was calculated according to Equation 1. The results are shown in Table 2.

$$O . I = {I}_{004} / {I}_{110} \qquad [ Equation 1 ]$$

In Equation 1,
I₀₀₄ represents the area of the peak representing the [0,0,4] crystal face in the X-ray diffraction spectroscopy (XRD) measurement of the negative electrode active layer,
I₁₁₀ represents the area of the peak representing the [1,1,0] crystal face in an X-ray diffraction (XRD) measurement of the negative electrode active layer.

Separately, for each manufactured negative electrode, three arbitrary points within a unit area of 10 cm across and 10 cm long were set on the surface of the second negative electrode active layer. Then, using a spectral colorimeter, the CIE color difference of the three points was measured. The average value of L* was obtained from the results of the three measured points, and the average value of the deviation of the three points from the average value of L* was calculated to obtain ΔL*. Then, the second negative electrode active layer on which the CIE colorimetry was measured was removed by exfoliation, and the CIE colorimetry was measured on the surface of the exposed first negative electrode active layer in the same way. The measured results are shown in Table 2 below.

TABLE 2

| | First negative electrode active layer | | | Second negative electrode active layer | | |
|---|---|---|---|---|---|---|
| | Alignment(O.I₁ₛₜ) | L* | ΔL | Alignment(O.I_{2nd}) | L* | ΔL |
| Example 1 | 0.21 | 34.13 | 0.2 | 0.19 | 32.85 | 0.1 |
| Example 2 | 0.24 | 34.22 | 0.2 | 0.18 | 32.56 | 0.2 |
| Example 3 | 0.27 | 34.91 | 0.3 | 0.18 | 32.79 | 0.2 |
| Example 4 | 0.57 | 39.06 | 0.2 | 0.31 | 34.11 | 0.3 |
| Comparative Example 1 | 0.33 | 39.06 | 0.3 | 0.19 | 32.98 | 0.4 |
| Comparative Example 2 | 0.18 | 34.55 | 0.4 | 0.19 | 32.75 | 0.3 |

### Comparative Example 3: Preparation of a Negative Electrode for a Lithium Secondary Battery

The negative electrode for lithium secondary battery was prepared by the same method as in Example 2, except that a magnetic field was not applied after casting of the first and second negative electrode slurries.

The first negative electrode active layer and the second negative electrode active layer of the prepared negative electrode had an alignment (O.I) of 5.41 and 16.87 for carbon-based active materials, respectively. In addition, the L* and ΔL of the first negative electrode active layer were 43 and 0.4, respectively, and the L* and ΔL of the second negative electrode active layer were 39 and 0.3, respectively.

### Examples 5 to 8 and Comparative Examples 4 to 6. Preparation of a Lithium Secondary Battery

LiNi_{0.7}Co_{0.1}Mn_{0.1}Al_{0.1}O₂ with a particle size of 5 μm was prepared as a positive electrode active material, mixed with polyvinylidene fluoride as a carbon-based conductive material and binder in a weight ratio of 94:3:3 in N-methyl pyrrolidone (NMP) to form a slurry, cast on an aluminum thin plate, dried in a vacuum oven at 120° C., and rolled to prepare a positive electrode.

A separator made of 18 μm of polypropylene was interposed between the positive electrode obtained above and the negative electrode prepared in Examples 1~4 and Comparative Examples 1-3, respectively, and inserted into the case, and then an electrolyte composition was injected to assemble the lithium secondary battery.

The type of negative electrode applied to each lithium secondary battery is shown in Table 3 below.

TABLE 3

| | Type of negative electrode applied |
|---|---|
| Example 5 | Negative electrode prepared in Example 1 |
| Example 6 | Negative electrode prepared in Example 2 |
| Example 7 | Negative electrode prepared in Example 3 |
| Example 8 | Negative electrode prepared in Example 4 |
| Comparative | Negative electrode prepared in Comparative |
| Example 4 | Example 1 |
| Comparative | Negative electrode prepared in Comparative |
| Example 5 | Example 2 |
| Comparative | Negative electrode prepared in Comparative |
| Example 6 | Example 3 |

### Experimental Examples

The following experiments were conducted to evaluate i) the adhesion between the negative electrode current collector and the negative electrode active layer and ii) the energy density of the negative electrode according to the present technology.

### a) Evaluation of Adhesion Between Negative Electrode Current Collector and Negative Electrode Active Layer

Specimens were manufactured by cutting the negative electrodes prepared in Examples 1~4 and Comparative Examples 1-3 so that the horizontal and vertical lengths were 25 mm and 70 mm, respectively.

Using double-sided tape, the prepared specimen was attached to the glass plate, with the current collector facing the glass plate. After fixing the specimen on the glass plate in the tensile tester, the negative electrode active layer of each negative electrode was exfoliated at an angle of 90° at a speed of 100 mm/min at 25° C. The exfoliation force measured in real time was defined as the interfacial adhesion between the negative electrode current collector and the negative electrode active layer, and the measured results are shown in Table 4 below.

### b) Evaluation of Energy Density

Each negative electrode prepared in Examples 1~4 and Comparative Examples 1-3 was drilled to have a hole with a size of 2 cm², and a constant current charge and discharge by the three-terminal method was performed to measure the charge and discharge capacity. Specifically, the energy density evaluation of each negative electrode was measured by making a sample cell containing each negative electrode as a sample electrode. Here, the sample cell was designed to have a structure comprising a laminate of each negative electrode, a separator, and a counter electrode, with a reference electrode introduced on the upper part separately. Furthermore, the sample cells were applied with a solution of LiPF₆ dissolved in a mixed solution of ethylene carbonate (EC) and methylethyl carbonate (MEC) (EC:MEC=1:2, vol.:vol.) to a concentration of 1 M as the electrolyte 10, and metal lithium was used as the counter electrode and reference electrode, and a polyethylene microporous membrane was used as the separator.

The obtained sample cells were charged to 0 V (V vs. Li/Li⁺) with a constant current of 0.2 mA/cm² for the surface area of each negative electrode, and discharged to 1 V (V vs. Li/Li⁺) with a constant current of 0.2 mA/cm², and the initial charge/discharge efficiency per unit volume of each sample cell was calculated. The results are shown in Table 4 below.

TABLE 4

| | Adhesion | Initial charge/discharge |
|---|---|---|
| | [gf/cm] | efficiency [%] |
| Example 1 | 41 | 95.3 |
| Example 2 | 43 | 95.0 |
| Example 3 | 38 | 94.7 |
| Example 4 | 40 | 93.8 |
| Comparative Example 1 | 21 | 93.5 |
| Comparative Example 2 | 11 | 95.4 |
| Comparative Example 3 | 9 | 92.1 |

As shown in Table 4, it can be seen that the negative electrode for lithium secondary battery according to the present disclosure had a high adhesion between the negative electrode current collector and the negative electrode active layer and a large energy density. Specifically, the negative electrodes prepared in the examples required an exfoliation force of more than 35 gf/cm to exfoliate the negative electrode current collector and the negative electrode active layer, and have an initial charge/discharge efficiency of 93.6% or more.

This means that the negative electrodes of the examples have a structure in which a first negative electrode active layer and a second negative electrode active layer are stacked sequentially on the negative electrode current collector, and the first negative electrode active layer includes synthetic graphite and natural graphite as carbon-based negative electrode active materials, wherein by controlling the alignment (O.I₁ₛₜ) of the carbon-based negative electrode active material contained in the first negative electrode active layer and the content of synthetic graphite in a certain range, the adhesion of the negative electrode active layer to the negative electrode current collector is increased, and the electrical performance of the negative electrode active layer is improved.

From these results, it can be seen that the negative electrode for a lithium secondary battery according to the present disclosure has excellent adhesion between the negative electrode current collector and the negative electrode active layer and high energy density.

Although the above has been described with reference to a aspects of the present disclosure, it will be understood by those skilled in the art or having ordinary knowledge in the art that various modifications and changes can be made to the aspects of the present disclosure without departing from the field of thought and technology described in the following claims.

Accordingly, the technical scope of the present disclosure is not limited to what is described in the detailed description of the specification, but should be defined by the claims.

1. A negative electrode for a lithium secondary battery comprising:
a negative electrode current collector; a first negative electrode active layer provided on at least one surface of the negative electrode current collector and containing a first carbon-based negative electrode active material; and a second negative electrode active layer provided on the first negative electrode active layer and containing a second carbon-based negative electrode active material,
wherein the first carbon-based negative electrode active material includes natural and synthetic graphite, and
wherein the first negative electrode active layer has a first alignment (O.I₁ₛₜ) of the first carbon-based negative electrode active material and the second negative electrode active layer has a second alignment (O.I_{2nd}) of the second carbon-based negative electrode active material,
wherein each of the first and second alignments (O.I) are from 0.1 to 0.9, as represented by Equation 1:
$$O . I = {I}_{004} / {I}_{110} \qquad [ Equation 1 ]$$
wherein, in the Equation 1,
I₀₀₄ represents an area of a peak representing the [0,0,4] crystal face in an X-ray diffraction spectroscopy (XRD) measurement of the first or second negative electrode active layer, and
I₁₁₀ represents an area of a peak representing the [1,1,0] crystal face in an X-ray diffraction (XRD) measurement of the first or second negative electrode active layer.

2. The negative electrode of claim 1, wherein a content of synthetic graphite exceeds 50 wt % with respect to a total weight of the first carbon-based negative electrode active material.

3. The negative electrode of claim 1, wherein the second carbon-based negative electrode active material includes synthetic graphite.

4. The negative electrode of claim 1, wherein:
the synthetic graphite is in the form of a flaky particle, and
the natural graphite is in the form of a spherical particle.

5. The negative electrode of claim 1, wherein:
an average particle size of the synthetic graphite is between 5 μm and 20 μm;
an average particle size of the natural graphite is between 15 μm and 25 μm; and
the average particle size of the synthetic graphite is smaller than the average particle size of natural graphite.

6. The negative electrode of claim 1, wherein a total thickness of the first negative electrode active layer and the second negative electrode active layer is 50 μm to 300 μm.

7. The negative electrode of claim 1, wherein an average thickness of the first negative electrode active layer has a ratio of 10% to 100% with respect to an average thickness of the second negative electrode active layer.

8. The negative electrode of claim 1, wherein the alignment (O.I_{2nd}) of the second carbon-based negative electrode active material has a ratio of 10% to 100% with respect to the alignment (O.I₁ₛₜ) of the first carbon-based negative electrode active material.

9. A manufacturing method of a negative electrode for a lithium secondary battery, the method comprising:
applying a first negative electrode slurry including a first carbon-based negative electrode active material on a surface of a current collector and simultaneously applying a second negative electrode slurry including a second carbon-based negative electrode active material on a surface of the first negative electrode slurry;
applying a magnetic field to the applied first negative electrode slurry and the second negative electrode slurry; and
forming a first negative electrode active layer and a second negative electrode active layer by drying the first negative electrode slurry and the second negative electrode slurry to which the magnetic field was applied,
wherein the first carbon-based negative electrode active material includes natural and synthetic graphite, and
the first negative electrode active layer has a first alignment (O.I₁ₛₜ) of the first carbon-based negative electrode active material and the second negative electrode active layer has a second alignment (O.I_{2nd}) of the second carbon-based negative electrode active material,
wherein each of the first and second alignments (O.I) are from 0.1 to 0.9, as represented by Equation 1:
$$O . I = {I}_{004} / {I}_{110} \qquad [ Equation 1 ]$$
wherein, in the Equation 1,
I₀₀₄ represents an area of a peak representing the [0,0,4] crystal face in an X-ray diffraction spectroscopy (XRD) measurement of the first or second negative electrode active layer,
I₁₁₀ represents an area of a peak representing the [1,1,0] crystal face in an X-ray diffraction (XRD) measurement of the first or second negative electrode active layer.

10. The manufacturing method of claim 9, wherein the magnetic field applied is a magnetic field of 2,000G to 6,000G.

11. The manufacturing method of claim 9, wherein the magnetic field is applied for 5 to 60 seconds.

12. The manufacturing method of claim 9, wherein the forming of the first negative electrode active layer and the second negative electrode active layer comprises:
drying the first negative electrode slurry and the second negative electrode slurry; and
rolling the dried first negative electrode slurry and second negative electrode slurry.

13. The negative electrode of claim 1, wherein the first carbon-based active material in the first negative electrode active layer has a higher alignment (O.I) than the second carbon-based active material in the second negative electrode active layer.

14. The negative electrode of claim 1, wherein the second negative electrode active layer has an L* value of 40 or less and a ΔL* of less than 10 in a CIE colorimetric analysis of any three points located on a surface of the second negative electrode active layer.

15. The negative electrode of claim 1, wherein the first negative electrode active layer further comprises a silicon-based negative electrode active material in an amount of 1 to 20 wt. % based on a total weight of the first carbon-based negative electrode active material and the silicon-based negative electrode active material.

16. The negative electrode of claim 1, wherein the second negative electrode active layer further comprises a silicon-based negative electrode active material in an amount of 1 to 20 wt. % based on a total weight of the second carbon-based negative electrode active material and the silicon-based negative electrode active material.

17. A lithium secondary battery comprising an electrode assembly including a positive electrode, a negative electrode, and a separator disposed between the positive electrode and the negative electrode,
wherein the negative electrode comprises a negative electrode current collector; a first negative electrode active layer provided on at least one surface of the negative electrode current collector and containing a first carbon-based negative electrode active material; and a second negative electrode active layer provided on the first negative electrode active layer and containing a second carbon-based negative electrode active material,
wherein the first carbon-based negative electrode active material includes natural and synthetic graphite, and
wherein the first negative electrode active layer has a first alignment (O.I₁ₛₜ) of the first carbon-based negative electrode active material and the second negative electrode active layer has a second alignment (O.I_{2nd}) of the second carbon-based negative electrode active material,
wherein each of the first and second alignments (O.I) are from 0.1 to 0.9, as represented by Equation 1:
$$O . I = {I}_{004} / {I}_{110} \qquad [ Equation 1 ]$$
wherein, in the Equation 1,
I₀₀₄ represents an area of a peak representing the [0,0,4] crystal face in an X-ray diffraction spectroscopy (XRD) measurement of the first or second negative electrode active layer, and
I₁₁₀ represents an area of a peak representing the [1,1,0] crystal face in an X-ray diffraction (XRD) measurement of the first or second negative electrode active layer.

18. The lithium secondary battery of claim 17, further comprising an electrolyte composition comprising a lithium salt and a non-aqueous organic solvent.

19. The lithium secondary battery of claim 17, wherein the positive electrode comprises a positive electrode active material comprising one or more lithium metal oxides represented by Chemical Formula 1 or Chemical Formula 2: 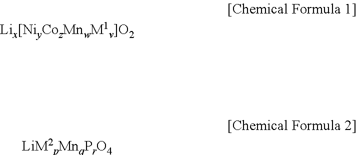
wherein in Chemical Formula 1 and Chemical Formula 2,
M¹ comprises one or more of W, Cu, Fe, V, Cr, Ti, Zr, Zn, Al, In, Ta, Y, La, Sr, Ga, Sc, Gd, Sm, Ca, Ce, Nb, Mg, B, or Mo,
1.0≤x≤1.30, 0.5≤y<1, 0<z≤0.3, 0<w≤0.3, 0≤v≤0.1, and y+z+w+v=1,
M² is Ni, Co, or Fe,
p is 0.05≤p≤1.0,
q is either 1-p or 2-p, and
r is 0 or 1.

20. The lithium secondary battery of claim 17, wherein:
an average particle size of the synthetic graphite is between 5 μm and 20 μm;
an average particle size of the natural graphite is between 15 μm and 25 μm; and
the average particle size of the synthetic graphite is smaller than the average particle size of natural graphite.
